(19) United States
(12) Patent Application Publication
(10) Pub. No.: US 2013/0040662 A1
(43) Pub. Date: Feb. 14, 2013

(54) PORTABLE COMMUNICATION DEVICE AND METHOD FOR DISPLAY OF BLACK SCREEN CONTENT

(71) Applicant: Martin Elisco, Chicago, IL (US)

(72) Inventor: Martin Elisco, Chicago, IL (US)

(21) Appl. No.: 13/584,491

(22) Filed: Aug. 13, 2012

Related U.S. Application Data
(60) Provisional application No. 61/523,346, filed on Aug. 14, 2011.

(51) Int. Cl. H04W 88/02; H04W 4/02

(52) U.S. Cl. 455/456.3; 455/566

(57) ABSTRACT

A portable communication device having a processor, a battery with a battery sensor, a display screen and a proximity sensor. The processor receives a signal from the display screen indicating whether the display screen is in a disabled state. The processor also receives a signal from the battery sensor indicating the remaining charge of the battery and the processor compares the remaining charge of the battery to a low power threshold. The processor also receives a signal indicating whether the proximity sensor is uncovered. If the display screen is in a disabled state, the remaining charge exceeds the low power threshold and the proximity sensor is uncovered, the device displays content. In certain embodiments, the device transmits a signal identifying the location of the device. In response, the device receives content based on the location of the device and stores the content in memory, filling a queue.

### CROSS REFERENCE TO RELATED APPLICATION

This application claims the benefit of Provisional Application Ser. No. 61/523,346, filed Aug. 14, 2011, the disclosure of which is incorporated in its entirety herein by reference to provide continuity of disclosure.

### FIELD OF THE DISCLOSURE

The present disclosure relates generally to portable communication devices. More particularly the present disclosure relates to methods for displaying content on such a device that is not actively in use by the consumer and devices configured for displaying content under such circumstances.

### BACKGROUND

Electronic mobile communications device users, such as mobile phone users are increasingly running large numbers of simultaneous software applications on their phones. Each application uses device resources in different ways and at different times. Certain applications which run constantly on these devices are necessary for monitoring data streams such as voice calls, e-mails, or text messages while others run at all times to receive notifications like weather alerts or breaking news. The multitude of “always-on” applications contribute to significant current drain on the mobile electronic device and with a fixed battery capacity, these applications limit the useful life of the device between recharging. One known and commonly used method for limiting current drain in mobile applications is to keep the display of the device disabled when the device is not in use, meaning that the display is a “black screen.” For phones having a touch screen, the black screen display state typically corresponds to a locked or inactive touchscreen that is unable to receive user input.

On known mobile phones, certain events or notifications can activate a display in the black screen state. For example, incoming phone calls wake a black screen display. However, these notifications occur at unspecified times whenever an outside event triggers them. Such notifications do not use other device sensors to decide whether to activate the display or not.

Another aspect of modern mobile communication devices is the display of advertisements by certain applications which run on these devices. For example, advertisements are displayed at the launch of or during operation of certain mobile device games, or other such applications. One drawback of that type of advertisement is that it typically delays or interrupts the user from viewing the game or other content being displayed by the application. Thus, the advertisement may be considered a distraction or nuisance to a user who is engaged in the application.

On non-mobile phone platforms such as personal computers and some electronic books readers, advertisements are displayed when the device is not actively being used. However, these devices are typically either always connected to a power source (such as desktop personal computers) or use special low-power display technology (such as certain e-book readers). Such advertisements are also displayed when a user is not present. In the case of an e-book, such advertisements may be disadvantageously displayed when the e-book is stored in a bag or purse. Applying such indiscriminate display of advertisements to a smartphone would drain the battery of the phone and result in dissatisfied users.

### SUMMARY

In various embodiments according to the present disclosure, a portable communication device has a processor, a battery with a battery sensor, a display screen and a proximity sensor. The processor receives a signal from the display screen indicating whether the display screen is in a disabled, or in other words black screen, state. The processor also receives a signal from the battery sensor indicating the remaining power level of the battery and the processor compares the remaining charge of the battery to a low power threshold. The processor also receives a signal indicating whether the proximity sensor is uncovered. If the remaining power level exceeds the low power threshold and the proximity sensor is uncovered, the device displays content from a queue of stored content. In certain embodiments, the displayed content is based on or related to the location of the device. Independent of the state of the display screen, the device transmits a signal identifying the location of the device at a frequency. In response, the device receives content based on the location of the device and stores the content in memory, filling the queue of stored content.

The application manages the display of content on a device screen when the device screen is otherwise going unused by other applications, including the base operating system. One such device for performing these functions has a display, button(s) or touchscreen, proximity sensor, battery sensor, processor, memory, and at least one method of wireless data transmission (e.g. cellular, WiFi, etc.). Additional details regarding the device are described below. The device is generally powered on for extended periods of time in order to be available to receive events such as incoming voice calls, text messages, or e-mail. These events are sporadic and even with other uses for the device, the time the device is powered on is greater than or equal to the time it is actively in use with the display turned on. This period of inactivity where the device is powered on, but has an unused display is used by the methods and devices disclosed herein to display many types of content at varying intervals. Such an implementation requires the use of novel methods and applications in order to reduce power consumption and avoid displaying content to a phone that is stored in a user's pocket, bag or purse, where such content will go unseen.

### BRIEF DESCRIPTION OF THE DRAWINGS

FIG. 1 is a flow chart for one embodiment of a method for displaying content on an electronic communication device according to the present disclosure.

FIG. 2 is a graph illustrating the relationship of display frequency to battery charge for both the charging and discharging device states of a device according to the present disclosure.

FIG. 3 is a front view of an embodiment of an electronic device according to the present disclosure.

FIG. 4 is a chart illustrating a subsection of the method of FIG. 1 related to battery meter and proximity sensor input and the system resources utilized to execute these instructions.

FIG. 5 is a chart illustrating a subsection of the method of FIG. 1 related to sharing a device's location, receiving content, displaying content, and detecting interaction with the content and the system resources utilized to execute these instructions.

FIG. 6 is a schematic diagram of an embodiment of an electronic device according to the present disclosure.

### DETAILED DESCRIPTION

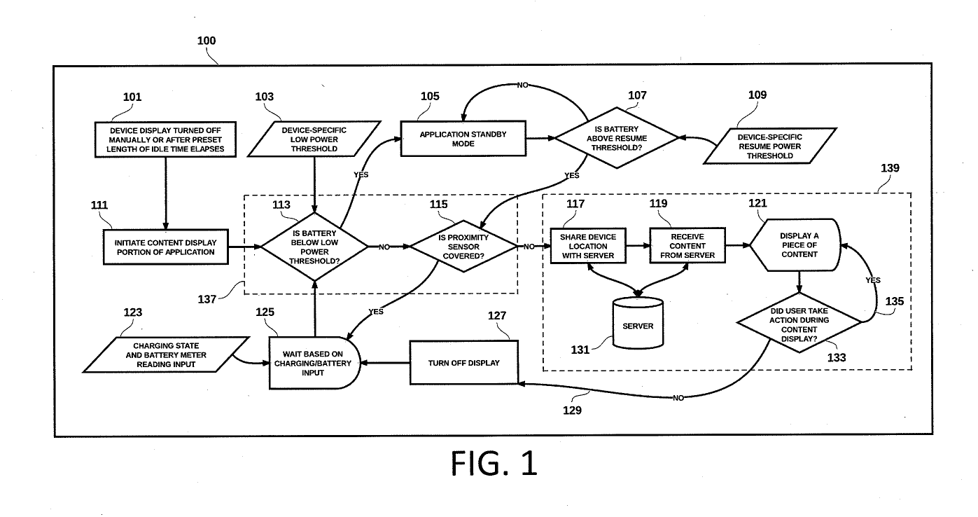

FIG. 1 illustrates an embodiment of a method of the present disclosure, including the events, decisions, and inputs utilized to determining appropriate times to display content. The entire set of illustrated instructions 100 make use of a variety of device sensors and inputs which enable it to strategically display content on the display of the device, which is described below in more detail. Certain portions of the methods described herein may be embodied as code or in an application. In one embodiment, that application runs at startup as a background event when the device is powered on. Alternatively, the application can be launched manually by a user. As discussed in more detail below, the application monitors device inputs and sensors in order to determine when to execute certain commands.

After the application has been launched, first, the application detects that the display is in a disabled state 101, meaning that it is in a black screen or standby mode because it was placed in that state either manually by a user or after a configurable preset idle screen time threshold is surpassed or by some other automated trigger. In certain embodiments, the disabled state of the display screen may also correspond to a “locked” touchscreen mode. Once the display is in the disabled state, the content display portion of the application initiates 111 and a series of decision points are analyzed by the program.

The first check of the content display portion is a comparison 113 of the remaining power stored in the battery to a low power threshold 103. The low power threshold 103 is specific to the device and may be pre-defined as a fixed value in the application or user-configurable within the application. If the comparison 113 of the remaining charge to the low power threshold 103 determines that the remaining charge is below the threshold, the application will enter a standby mode 105 in which it uses very low power. While in the low power standby mode 105, the application compares 107 the remaining power in the battery to a device specific resume power threshold 109. The device specific resume power threshold 109 may be predefined as a fixed value within the application, calculated relative to the low power threshold 103, or user-configurable within the application. As long as the comparison 107 of the remaining power in the battery to the resume power threshold 109 determines the remaining power is below the threshold 109, the application remains in the low power standby mode 105.

If either the comparison 113 of the remaining power in the battery to the low power threshold 103 determines that the remaining power is above the threshold 103 or the comparison 107 of the remaining power in the battery to the resume power threshold 109 determines that the remaining power is above the threshold 109, the application proceeds with further instructions checking to see if the proximity sensor is covered 115. Proximity sensor 411 may be any number of sensors that detect the presence of an object proximate the sensor. For example, proximity sensor 411 could include a capacitive, photoelectric, infrared, electromagnetic or inductive sensor.

Proximity sensors are traditionally used within live applications such as phone applications to detect when a user is bringing the device to his or her ear so that the display and touchscreen can be disabled, thus preventing inadvertent touchscreen input from the user's face. In the present disclosure, the proximity sensor is utilized to determine whether an object (e.g. table, pocket, purse, etc.) is blocking the front of the device prior to displaying content. If the check of the proximity sensor 115 determines that the sensor is covered, the application waits 125 for a period of time before initiating another such check. In one embodiment, the period of time for which it waits is based on input 123 about the current state of charging/discharging and the remaining power in the battery. In other embodiments, this time period may be preset and unchanging.

If the check of the proximity sensor 115 reveals that the sensor is uncovered, the device proceeds to display content 121 for a pre-defined length of time. While the content is displayed 121, the application monitors the device, looking for input from the user through a user input device, such as a touch screen. If the application determines action from the user 133, the program returns 135 to the content display 121 command to display a new piece of content. It is understood that if the monitoring of user action 133 on successive content displays 121 continues to result in user action 135, then at times user action 135 will return the program to either refresh the device location 117 and/or receive more content 119 from the server 131. In this way, the user can quickly view multiple advertisements or non-commercial content specific to his or her location to see if any of them are of interest to him or her. If the monitoring of user action 133 results in no action by the user 129 in the time during content display, the display will be turned off 127 and the application will wait 125 for a period of time. In this embodiment, the period of time is based on input 123 about the remaining battery power and/or charging state of the battery. In other embodiments, the period of time may be pre-set. Alternatively, this period of time may be based on other factors, as described below. After waiting, the method returns to the steps of comparing the remaining charge to the low power threshold 113 and checking the state of the proximity sensor 115.

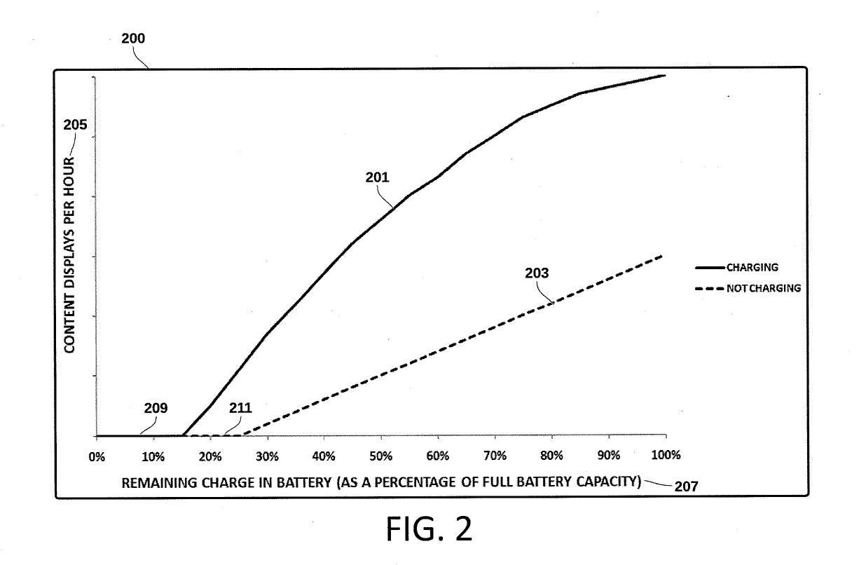

FIG. 2 shows a graph 200 which provides more detail on how the wait duration 125 might be influenced by the inputs 123 of the remaining charge in the battery 207 and the charging state of the device. The number of content displays per hour 205 can be translated into a wait time 125 between pieces of content once the content display frequency 205 has been established. It will be understood that graph 200 does not depict the only possible implementation of content display frequency 205 relative to device inputs 123, but instead it provides characteristics of content display of one embodiment of the present disclosure. When the battery is charging 201, 209 content display occurs at a frequency 205 greater than or equal to the frequency 205 when not charging 203 and 211. At low levels of charge remaining in the battery 207, the application standby mode 105 is illustrated as a display frequency 205 of zero whether charging 209 or not charging 211. It is contemplated that if the battery is charging 201, 209, the resume power threshold 109 may be lower than it would be if the battery is not charging 203, 211.

In addition to the battery input 123, it is understood that in certain embodiments other variables such as time of day or location of device may affect the rate of content display 205. The application may also adjust content display frequency 205 based on learned user behavior such as the typical frequency of charging the device. Such user charging behavior information may be stored in a memory 407. If the application recognizes a pattern of the device being charged every 12 hours on certain days, display frequency can be increased compared to 18 hours between charges on other days. This behavior seeks to maximize content display frequency while minimizing the likelihood of the remaining battery power 207 reaching zero.

As shown in FIG. 1, in certain embodiments, the device also transmits 117 a location identification and receives content 119 targeted to the device's location for display on the screen. It will be understood that steps 117 and 119 of FIG. 1 may be performed as a separate operation, independent of and not contingent upon checks 113 and 115. The location identification may be a zip code, GPS coordinates, longitude and latitude, or other geographic identifier. If the server recognizes the location as one in which the service is currently operating, the device then receives appropriate content 119 from the server 131 based on the shared location 117.

In certain embodiments, the received content is stored in a queue in a memory (described below) in the device for later retrieval. If the location 117 happens to be outside of the current operating range of the content delivery service, the content 119 might take the form of a message notifying the user that their current location is not supporting the delivery of content at this time.

In other embodiments, the server may provide content that is not specific to the location. In such embodiments, the device need not transmit a location identification to a server.

In certain embodiments the content is a set of advertisements particularly targeted to the user's location. For example, advertisements may be directed to informing users about goods or services offered by a business near the user's location. The content may also or alternatively include coupons or offers to the user that are targeted to the user's location. In certain embodiments some or all of the content may be non-advertising or non-commercial. For example, the system can be used to display public service announcements.

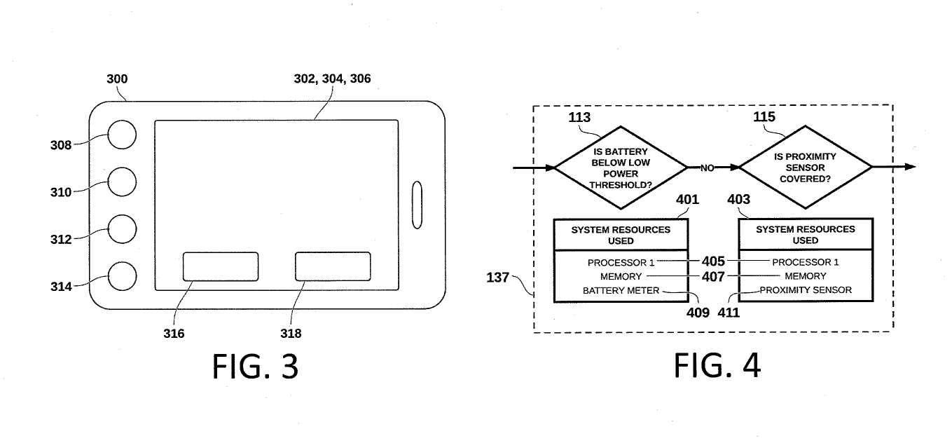

FIG. 3 illustrates an embodiment of an electronic device 300 according to the present disclosure having a display screen 302. Display screen may include one or more of a liquid crystal display (LCD), dot matrix display, light emitting diode display (LED), organic light emitting diode display (OLED) or similar displays and other such similar displays capable of providing visible information to a user. The device also includes one or more user input devices, which receive user input such as button pushes or swipes. One user input device included in this embodiment is a touchscreen 304, which is shown in FIG. 3 displaying a full-screen piece of content 306. Touchscreen 304 may be a capacitive or resistive touchscreen or other similar screen capable of detecting the presence and location of a touch.

Other user input devices shown in this embodiment are keys 308, 310, 312, 314 for input, and virtual keys 316, 318, which are displayed on the display screen with the content. However, other key configurations may be used. When content 306 is displayed 121, the application monitors the user input devices for user action 133 on one or more of the user input devices. In some cases, the action taken by a user may be confirmed on the display 302 prior to displaying a new piece of content 121.

FIG. 4 illustrates a subsection 137 of FIG. 1 relating to the decision of whether to launch the content display mode, sometimes referred to herein as the decision functions, and specific to the two decision points 113, 115 which are implemented prior to any content location sharing 117, content transfer 119, or content display 121. Along with the reproduced portion of FIG. 1, FIG. 4 identifies certain device resources used 401, 403 to execute the commands within subsection 137. When determining 113 if the remaining battery power is below the low power threshold 103, the device uses various system resources 401. Specifically, the device uses the processor 504 to compare the current battery level detected by the battery meter 409 to the low battery threshold stored in memory 407. Similarly, when determining whether the proximity sensor is covered 115, the device uses a different set of device resources 403. Some resources like a processor 405 and memory 407 are used throughout the subsection 137. However, when comparing battery power 113, the method utilizes the device battery meter 409; and, when determining the state of the proximity sensor 115, the proximity sensor 411 is used. Both the proximity sensor 411 and battery meter 409 have the beneficial feature of drawing very little current during operation. Thus, the decision functions of subsection 137 are low power functions.

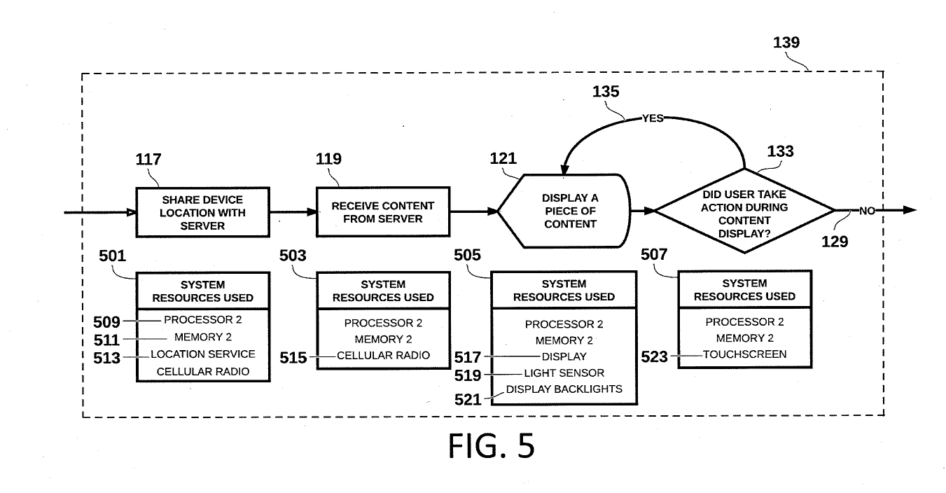

FIG. 5 illustrates subsection 139 of the method of FIG. 1 relating to content display, sometimes referred to herein as the content display functions, and specific to the four instructions immediately preceding, during, and after content display 121. Along with the reproduced portion of FIG. 1, FIG. 5 adds lists of general system resources used 501, 503, 505, 507 used in one embodiment to execute the commands within subsection 139. In this embodiment, when sharing the device 25 location with a server 117, the application uses one set of system resources 501. These resources 501 include a second processor 509, a second memory 511, location services 513, and a cellular radio 515. The location services 513 used while sharing the device location with the server 117 may include the use of any location tracking technology including, but not limited to: global positioning system (GPS) receivers, cellular tower tracking, or WiFi network tracking. A transmitter, such as a cellular radio 515, is used to transmit data wirelessly between the device and server and may also aid in the performance of any GPS receiver that may be utilized.

When receiving content from a server 119, the application uses a similar set of system resources 503. After receiving the content 119, display of the content 121 uses a different set of resources 505 including the use of a display 517, light sensor 519, and display backlights 521. The display 517 and display backlights 521 are used jointly to produce an image on the device, while the backlight sensor 519 is often used on electronic devices to set the display backlights 521 to the proper brightness for the ambient lighting conditions. Finally, when monitoring the content display for user action 133, the list of system resources used 507 includes a touchscreen 523.

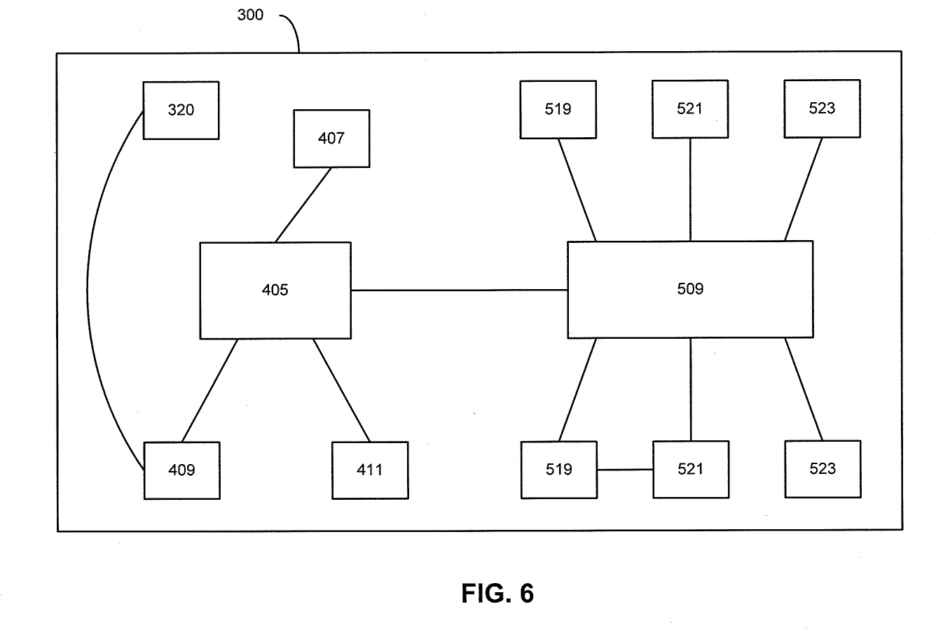

FIG. 6 shows a schematic view of an embodiment of the device having a first processor 405 and a second processor 509. The first processor 405 is communicatively connected with the first memory 407, the proximity sensor 411 and the battery meter 409, which is in communication with the battery 320. The second processor 509 is communicatively connected with the second memory 511, the location service 513, the transmitter 515, the display 517 a light sensor 519, display backlights 521 and touchscreen 523.

It can now be recognized that in the embodiment shown in FIGS. 4 and 5, subsection 137 of both FIGS. 1 and 4 is a low power, low system resources section of the overall set of application commands 100. Conversely, subsection 139 is a higher power section of the overall application which requires a greater number of system resources. The fact that the low-power, low-resource checks occur prior to expending significant amounts of current on content display activities minimizes the use of power when the device is not likely to be viewed. It also prevents the application from draining the battery when the battery is already low. Further power savings can be recognized through use of a low-power processor 405 and memory 407 exclusively for monitoring the battery meter 113 and proximity sensor 115. The low-power components are more efficient than utilizing the main system processor 509 and memory 511 which are typically used for high powered applications such as video decoding and display.

In an alternative embodiment of a communication device, the same processor 405 may be used to perform the content display functions and the decision functions. Similarly, in certain embodiments, the same memory used in the decision functions is used in the content display functions.

Any process descriptions or blocks in figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

I claim:

1. A method for displaying content on a portable communication device having a display screen, a proximity sensor, a transmitter, a battery and a battery sensor, the method comprising the steps of:
receiving content;
determining whether the display screen is in a disabled state;
measuring, via the battery sensor, a remaining power level of the battery;
comparing the remaining charge of the battery to a low power threshold;
detecting via the proximity sensor whether the proximity sensor is uncovered; and
if the display screen is in a disabled state, the remaining charge exceeds the low power threshold and the proximity sensor is uncovered, initiating displaying the received content on the display screen.

2. The method of claim 1 further comprising the step of transmitting a location identification, and wherein the received content relates to the location identification.

3. The method of claim 1 wherein the received content includes a plurality of pieces of content and the plurality of pieces of content are displayed at a frequency.

4. The method of claim 3 wherein the frequency of display of the pieces of content is determined based on the remaining charge of the battery.

5. The method of claim 3 further comprising the steps of:
detecting whether the battery is charging; and
determining a frequency for displaying the pieces of content at least in part based on whether the battery is charging.

6. The method of claim 1 further comprising the steps of:
ceasing displaying the received content on the display screen if the remaining charge is less than the low power threshold.

7. The method of claim 6 further comprising the steps of:
comparing the remaining charge of the battery to a resume power threshold; and
if the remaining charge of the battery exceeds the resume power threshold, resuming displaying the received content on the display screen.

8. The method of claim 3 further comprising the steps of:
monitoring user battery charging behavior; and
determining a content display frequency based at least in part on the user battery charging behavior.

9. The method of claim 1 further comprising the steps of:
monitoring for user input when content is being displayed; and
if user input is detected, displaying content that is different from the content displayed when the user input was detected.

10. The method of claim 1 wherein the received content includes advertisements.

11. The method of claim 1 further comprising the steps of:
storing the received content in a memory; and
retrieving the received content from the memory.

12. The method of claim 11 further comprising the step of transmitting a location identification, and wherein the received content relates to the location identification.

13. A portable communication device comprising:
a processor;
a display screen in communication with the processor;
a battery;
a battery sensor in communication with the processor and configured to measure a remaining charge of the battery;
a proximity sensor in communication with the processor; and
a transmitter;
wherein the processor is configured to receive a signal from the display screen indicating whether the display screen is in a disabled state, receive a signal from the battery sensor indicating the remaining charge of the battery, compare the remaining charge of the battery to a low power threshold and receive a signal indicating whether the proximity sensor is uncovered; and
wherein, if the display screen is in the disabled state, the remaining charge exceeds the low power threshold and the proximity sensor is uncovered, the processor is further configured to cause the display screen to display content.

14. The portable communication device of claim 13 further comprising at least one user input device in communication with the processor, wherein, when the user input device receives input while the content is displayed, the processor is configured to display content different from the content displayed when the user input was received.

15. The portable communication device of claim 13 further comprising a memory configured to store user battery charging behavior information.

16. The portable communication device of claim 13, wherein the content includes a plurality of pieces of content and the plurality of pieces of content are displayed on the display screen at a frequency.

17. The portable communication device of claim 16, wherein the frequency of display of the pieces of content is based on the remaining charge of the battery.

18. The portable communication device of claim 16, wherein the frequency of display of the pieces of content is based on whether the battery is charging.

19. A portable communication device comprising:
a first processor;
a battery;
a battery sensor in communication with the first processor and configured to measure a remaining charge of the battery;
a proximity sensor in communication with the first processor;
a second processor;
a display screen in communication with the second processor;
a transmitter in communication with the second processor;
wherein the first processor is configured to receive a signal from the battery sensor indicating the remaining charge of the battery, compare the remaining charge of the battery to a low power threshold, and receive a signal indicating whether the proximity sensor is uncovered, and
wherein, if the display screen is in a disabled state, the remaining charge exceeds the low power threshold and the proximity sensor is uncovered, the second processor is configured to cause the display screen to display content.

20. The portable communication device of claim 19 further comprising at least one user input device in communication with the first processor, wherein, when the user input device receives input, the first processor is configured to display content different from the content displayed when the user input was received.

21. The portable communication device of claim 19, wherein the at least one user input device is a touchscreen.

22. The portable communication device of claim 19, wherein the content includes a plurality of pieces of content and the plurality of pieces of content are displayed on the display screen at a frequency.

23. The portable communication device of claim 22, wherein the frequency of display of the pieces of content is determined based on the remaining charge of the battery.

24. The portable communication device of claim 22, wherein the frequency of display of the pieces of content is determined at least in part based on whether the battery is charging.

25. A portable communication device comprising:
a processor;
a display screen in communication with the processor;
a battery;
a battery sensor in communication with the processor and configured to measure a remaining charge of the battery;
a proximity sensor in communication with the processor; and
a transmitter;
wherein, if the display screen is in a disabled state, the remaining charge exceeds a low power threshold and the proximity sensor is uncovered, then the device is configured to operate in a first mode, the first mode including displaying content on the display screen; and
wherein, if the remaining charge is less than the low power threshold and less than a resume power threshold, then the device is configured to operate in a second mode, the second mode including checking the remaining charge and comparing the remaining power level to the resume power threshold.

26. The portable communication device of claim 25, wherein the content includes a plurality of pieces of content and the plurality of pieces of content are displayed on the display screen at a frequency.

27. The portable communication device of claim 26 further comprising:
a memory configured to store user battery charging behavior information;
wherein the frequency of content display is based in part on the stored user battery charging behavior information.
